(19) United States
(12) Patent Application Publication
(10) Pub. No.: US 2025/0159485 A1
(43) Pub. Date: May 15, 2025

(54) CARRIER LOCKING BASED ON INTERFERENCE LEVEL

(71) Applicant: Telefonaktiebolaget LM Ericsson (publ), Stockholm (SE)

(72) Inventors: Oleg GORBATOV, Luleå (SE); Lackis ELEFTHERIADIS, Valbo (SE); Cecilia NYSTRÖM, Stockholm (SE); Erik SANDERS, Vallentuna (SE); Selim ICKIN, Danderyd (SE); Konstantinos VANDIKAS, Solna (SE); Helene HALLBERG, Stockholm (SE); Farnaz MORADI, Bromma (SE); Yak NG MOLINA, Malaga (ES)

(21) Appl. No.: 18/726,913

(22) PCT Filed: Mar. 21, 2022
(86) PCT No.: PCT/EP2022/057285

§ 371 Date: Jul. 5, 2024

(30) Foreign Application Priority Data
Jan. 12, 2022 (GR) 20220100022

(51) Int. Cl. H04W 16/10; H04W 24/08; H04W 52/02

(52) U.S. Cl. CPC H04W 16/10; H04W 24/08; H04W 52/0206

(57) ABSTRACT

A computer-implemented method performed by a network node to select at least one carrier to lock based on an interference level is provided. The method includes identifying at least one network node from a plurality of network nodes having a defined interference level related to defined traffic data and a energy consumption value. The method further includes, for the identified at least one network node, selecting with a machine learning, ML, model at least one carrier from a plurality of carriers to lock within a local zone.

### TECHNICAL FIELD

The present disclosure relates generally to methods to select a carrier to lock based on an interference and reduce energy consumption, and related methods and apparatuses.

### BACKGROUND

Interference can be a problem in radio communications including, e.g., that interference can negatively affect a transmitted signal from a base station (BS (e.g., a network node). For example, when interference is detected from internal hardware equipment and/or external sources, a BS processing unit may need to adjust parameters to make compensation to sustain a good quality of service (QOS) for a user equipment (UE).

An interference reduction approach may include inter-cell interference scheduling. Such an approach may allow for avoiding high inter-cell interference in parts of frequencies of a new radio (NR) band.

Another interference reduction approach may use artificial intelligence (AI) to help reduce interference. A transmitter output (Tx) power Tx-power optimization may be used to improve QoS. Such an approach does not focus on power saving. Another interference reduction approach may focus on defining a root cause of interference.

Another approach may allow an operator to soft lock one or several carriers. A soft lock may move UE traffic out of a carrier to another designated neighboring carrier, before entering a carrier lock state, which may result in UE traffic not being impacted or an impact on UE traffic being reduced. In other words, traffic may be moved to another carrier with minimal disturbance and a UE is offloaded to the another carrier. For example, when all UEs are moved, the carrier can be locked. A soft lock may allow minimizing a traffic impact at, e.g., a RAN software upgrade, where the soft upgrade includes a soft lock to remove the traffic before a restart. Such carrier soft lock may include dependencies in the mechanism such that the soft lock requires at least one session continuity feature and at least one handover feature to be active for the carrier soft lock feature to be operational.

Another soft lock approach may include a carrier(s) that is without radio traffic can be turned ON/OFF by software using a specific policy fixed scheme, which may avoid dropped calls. In such an approach, a machine learning (ML) process may recommend times to lock a carrier(s).

In an approach for performing link adaptation, a UE can produce different types of reports regarding channel state information (CSI) including (i) periodic/aperiodic reports about CSI data that contain current measurements about the channel as acquired by each UE; and (ii) predictive reports about CSI data that provide possible future states of the channel using different predictive models that can have a varying time horizon for a number of future timesteps that they predict in advance.

### SUMMARY

There currently exist certain challenges. Depending on the deployment, the number of radio units at a network node, and the selected frequencies (e.g., low, mid and high bands), interference can appear on the air interface. Additionally, energy consumption can increase and the increased energy consumption can be related to interference.

Certain aspects of the disclosure and their embodiments may provide solutions to these or other challenges.

In various embodiments of the present disclosure, a computer-implemented method is provided that is performed by a network node to select at least one carrier to lock based on an interference level. The method includes identifying at least one network node from a plurality of network nodes having a defined interference level related to defined traffic data and a energy consumption value. The method further includes, for the identified at least one network node, selecting with a machine learning, ML, model at least one carrier from a plurality of carriers to lock within a local zone.

In some embodiments, the method further comprises signaling a request to lock the selected at least one carrier.

In some embodiments, the method further comprises, when the selected carrier can be locked, calculating an energy efficiency of the selected carrier.

In other embodiments, a network node configured to select at least one carrier to lock based on an interference level is provided. The network node includes at least one processing circuitry; and at least one memory coupled with the processing circuitry, wherein the memory includes instructions that when executed by the processing circuitry causes the network node to perform operations. The operations comprise identify at least one network node from a plurality of network nodes having a defined interference level related to defined traffic data and a energy consumption value. The operations further comprise, for the identified at least one network node, select with a machine learning, ML, model at least one carrier from a plurality of carriers to lock within a local zone.

In other embodiments, a computer program comprising program code to be executed by processing circuitry of a network node to perform operations. The network node is configured to select at least one carrier to lock based on an interference level. Execution of the program code causes the network node to perform operations comprising identify at least one network node from a plurality of network nodes having a defined interference level related to defined traffic data and a energy consumption value. The operations further comprise, for the identified at least one network node, select with a machine learning, ML, model at least one carrier from a plurality of carriers to lock within a local zone.

In other embodiments, a computer program product comprising a non-transitory storage medium including program code to be executed by processing circuitry of a network node configured to select at least one carrier to lock based on an interference level. Execution of the program code causes the network node to perform operations. The operations comprise identify at least one network node from a plurality of network nodes having a defined interference level related to defined traffic data and a energy consumption value. The operations further comprise, for the identified at least one network node, select with a machine learning, ML, model at least one carrier from a plurality of carriers to lock within a local zone.

Certain embodiments may provide one or more of the following technical advantages. Based on a network node identifying at least one network node having a defined interference level related to defined traffic data and a energy consumption value, a carrier(s) may be selected for locking based on increased energy consumption related to interference. As a consequence, energy consumption and interference may be reduced. Additionally, based on inclusion of a ML model, the method may be accessible to implement and may be fast in selecting the carrier(s) to lock.

### BRIEF DESCRIPTION OF DRAWINGS

The accompanying drawings, which are included to provide a further understanding of the disclosure and are incorporated in and constitute a part of this application, illustrate certain non-limiting embodiments of inventive concepts. In the drawings:

FIG. 1 is a schematic diagram illustrating different frequency bands for coverage and capacity;

FIG. 1A1 is a schematic plot illustrating a local zone of FIG. 1;

FIG. 2 is a flowchart illustrating operations of network node in accordance with some embodiments of the present disclosure;

FIG. 3 is a block diagram illustrating an overview of operations of a network node in accordance with some embodiments of the present disclosure;

FIG. 4 is a plot illustrating an identified state of a network node in accordance with some embodiments of the present disclosure;

FIG. 5 are plots illustrating an example embodiment of distribution of interference for a physical uplink shared channel (PUSCH) signal-to noise-interference-plus noise ratio (SINR) below a first defined threshold and a physical uplink control channel (PUCCH) SINR below a second defined threshold in accordance with some embodiments of the present disclosure;

FIG. 6 is a flowchart illustrating operations in a network including the method in accordance with some embodiments of the present disclosure;

FIGS. 7-9 are flowcharts illustrating further operations of a network node in accordance with some embodiments of the present disclosure;

FIG. 10 is a schematic diagram illustrating an example visualization of cells relations information in accordance with some embodiments of the present disclosure;

FIG. 11 is a block diagram illustrating connected operations of the method of some embodiments of the present disclosure;

FIG. 12 is a flowchart illustrating operations of a network node implementing ML model in accordance with some embodiments of the present disclosure;

FIG. 13 is a block diagram illustrating implementation of isolated and centralized ML models of a network node in cloud layers in accordance with some embodiments of the present disclosure;

FIG. 14 is a block diagram of a communication system in accordance with some embodiments of the present disclosure;

FIG. 15 is a block diagram of a user equipment in accordance with some embodiments of the present disclosure;

FIG. 16 is a block diagram of a network node in accordance with some embodiments of the present disclosure; and

FIG. 17 is a block diagram of a virtualization environment in accordance with some embodiments of the present disclosure.

### DETAILED DESCRIPTION

Inventive concepts will now be described more fully hereinafter with reference to the accompanying drawings, in which examples of embodiments of inventive concepts are shown. Inventive concepts may, however, be embodied in many different forms and should not be construed as limited to the embodiments set forth herein. Rather, these embodiments are provided so that this disclosure will be thorough and complete, and will fully convey the scope of present inventive concepts to those skilled in the art. It should also be noted that these embodiments are not mutually exclusive. Components from one embodiment may be tacitly assumed to be present/used in another embodiment.

The following description presents various embodiments of the disclosed subject matter. These embodiments are presented as teaching examples and are not to be construed as limiting the scope of the disclosed subject matter. For example, certain details of the described embodiments may be modified, omitted, or expanded upon without departing from the scope of the described subject matter.

As referenced above, some existing approaches may provide features for interference reduction or carrier locking.

In such existing approaches, the QoS may be detected and adjusted based on interference disturbance. A problem with interference, however, is that it not only affects the quality of the air interface signal for UEs but it can also increase power consumption of the radio units in access network nodes.

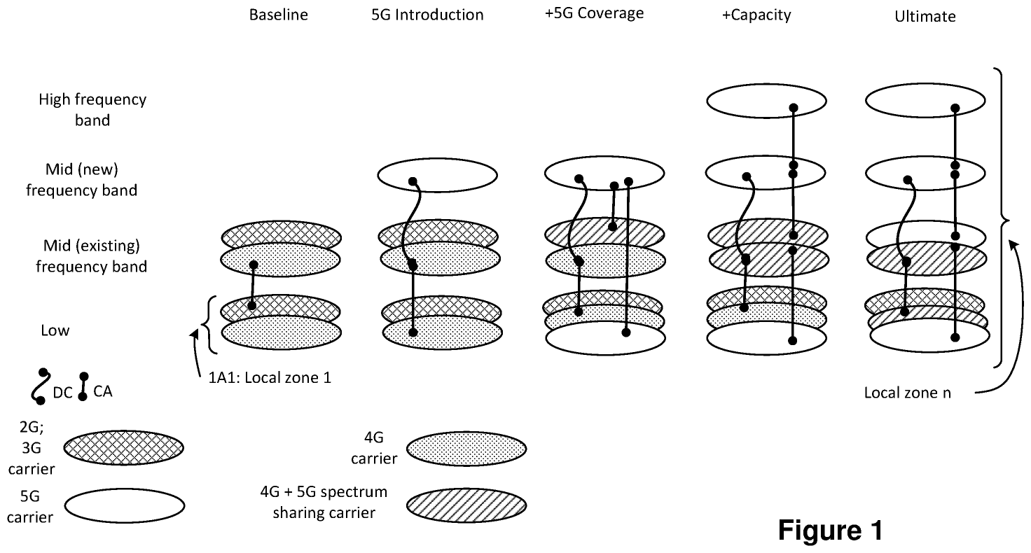

Mobile Network Operators (MNO) may be currently increasing their efforts to deploy new fifth generation (5G) technology on existing or new sites. New radio units of a network node can have new frequency bands.—FIG. 1 is a schematic diagram illustrating different frequency bands for coverage and capacity. Multiple frequency bands (e.g., low band (existing), mid band (new), and high band as illustrated in FIG. 1), can be deployed in local zone 1 . . . n that includes a network node to fulfill specific requirements for coverage and capacity. A baseline site can have a network node(s) with carriers in a low frequency band (e.g., second generation (2G)/third generation (3G) and fourth generation (4G) technology as illustrated in FIG. 1) and existing mid band (e.g., 2G/3G and 4G technology as illustrated in FIG. 1). As illustrated in FIG. 1, the introduction of 5G can include multiple frequency bands deployed in local zone n (discussed further regarding FIG. 1A1) that includes a network node to fulfill the requirement for coverage and capacity

FIG. 1A1 is schematic plot illustrating a local zone of FIG. 1. A local zone of FIG. 1A1 includes a network node (i.e., the illustrated “node”). A local zone is a geographic region that can be identified by a radius in a defined latitude and longitude area, and that includes a network node with carriers in the different frequencies illustrated in FIG. 1. As illustrated in FIG. 1A1, the local zone can include other network nodes (e.g., the illustrated other network nodes at 0-1 km and 1-2 km from the network node).

Depending on the deployment, the number of radio units at a network node, and the selected frequency (e.g., low, mid and high bands), interference can appear on the air interface. Although some existing approaches may avoid interfering frequency relations and/or an external frequency impact, energy consumption can increase and increased energy consumption can be related to interference.

Thus, there is a need for identifying interference related to energy consumption and reducing energy consumption.

Certain aspects of the disclosure and their embodiments may provide solutions to these or other challenges. A computer-implemented method performed by a network node (e.g., network node QQ300 discussed herein) is provided that can identify a carrier sleep proposal (also referred to herein as “cell sleep”) based on interference detection in relation to increased energy consumption. In some embodiments, the method locks or turns off a carrier that causes increased energy consumption based on the increased interference for the network node within its cell. In some embodiments, the method determines the carrier(s) with a low level of SINR and high-energy consumption to be locked.

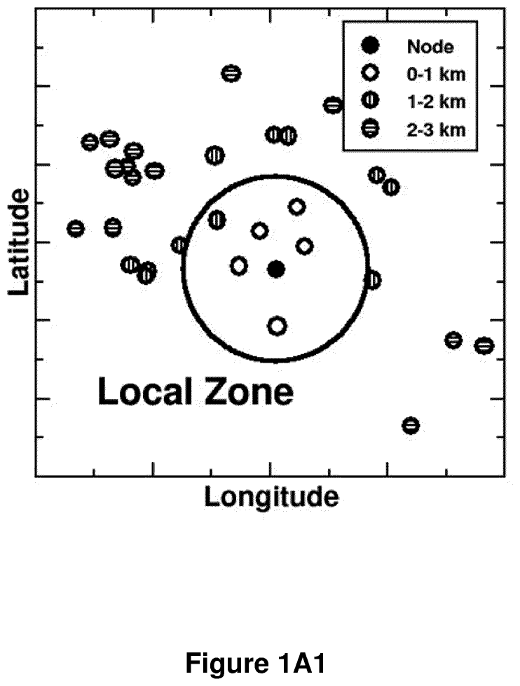

FIG. 2 is a flowchart illustrating operations of the computer-implemented method performed by the network node (e.g., network node QQ300) to select at least one carrier to lock based on an interference level in accordance with some embodiments of the present disclosure. The method includes identifying (201) at least one network node from a plurality of network nodes having a defined interference level related to defined traffic data and a energy consumption value. The method further includes for the identified at least one network node, selecting (203) with a machine learning, ML, model at least one carrier from a plurality of carriers to lock within a zone.

Certain embodiments may provide one or more of the following technical advantages. Based on the network node identifying at least one network node having a defined interference level related to defined traffic data and a energy consumption value, a selection for locking a carrier(s) may be made based on increased energy consumption related to interference. Such a selection may reduce energy consumption by enabling a carrier lock, e.g. for a short period, by identifying a carrier with high interference. Moreover, the method may also reduce interference. Based on inclusion of a ML model that selects at least one carrier to lock, the method may have low complexity and may not be computationally heavy. Additionally, based on inclusion of the ML model, the method may be accessible to implement and may offer an acceptable trade-off between performance and savings. Further, as a consequence of inclusion of the ML model, the method may be fast in making the selection, including a safety evaluation that can be quick (e.g., prediction of traffic, coverage, number of active carriers, etc.) before application of the locking/sleep mode.

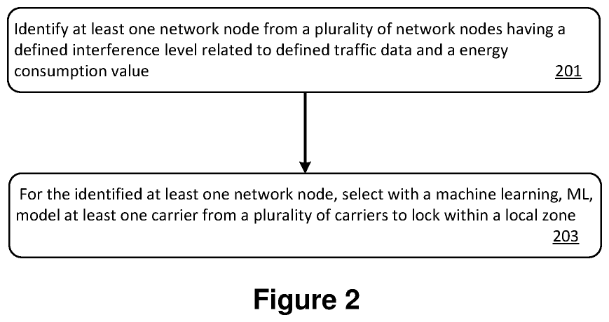

FIG. 3 is a block diagram illustrating an overview of operations of a network node (e.g., network node QQ300) in accordance with some embodiments of the present disclosure. Data preprocessing operations 301 include monitoring 301a of a network node, and collecting and preparing 301b input data for the method, discussed further herein.

In some embodiments, identifying (operation 201 of FIG. 2) includes ML based techniques like clustering and classification operations 303. Clustering and classification 303 can include network node clustering 303a, carrier clustering 303c, network node classification 303b, and carrier classification 303d.

In some embodiments, the identifying (201) is based on clustering techniques and classification of the plurality of network nodes.

In some embodiments, for a clustering technique, the logic that the technique operates on may be installed during implementation. For deployed systems, flexibility may be added during implementation. As a consequence, extended periods of time for training of a clustering technique (e.g., a ML model) may not be needed because, e.g., a small number of factors are used for clustering and classification. In an example embodiment, network node clustering 303a and network node classification 303b, and carrier clustering 303c and carrier classification 303d, are based on clustering and classification according to energy-efficient network nodes, non-energy-efficient network nodes, and remaining network nodes. These classes can be used in a future time period for multi-class classification using ensemble methods that provide higher predictive power than the results of any constituting learning algorithms independently. In some embodiments, random forest and/or gradient boosting classifiers can be used.

In some embodiments, the plurality of network nodes are clustered and classified based on at least one or more of (i) network nodes that are energy efficient, (ii) network nodes that are non-energy efficient determined by a SINR of at least one of a PUSCH and a PUCCH that is greater than or equal to a defined first threshold value and determined into different local zones, (iii) network nodes that are not energy efficient nodes determined by a SINR of at least one of a PUSCH and a PUCCH that is less than the defined first threshold value, and (iv) a remainder of the plurality of network nodes. Based on that classification the network nodes can be set and a local zone(s) can be defined around the non-efficient network nodes. The local zone that has worst energy efficient index, can be further improved. That is, in some embodiments, within the defined local zone (on non-efficient network nodes), the method includes checking and determining based on capacity of the defined local zone (and other parameters discussed herein) a carrier to lock.

In some embodiments, the results obtained from clustering and classification operations 303 are compared with clustering obtained by applying a density-based spatial clustering of applications with noise (DBSCAN) algorithm. Network nodes with similar behavior can reside in a region in the features space close to each other and can be grouped in a cluster.

In some embodiments, because a clustering technique is used for clustering, the clustering technique can isolate and train one clustering technique (e.g., one ML model) per network node and/or the training can be centralized.

In some embodiments, the ML model of the selecting operation (operation 203 of FIG. 2) is either a classification model or a regression model (305) that predicts key performance indicators (KPIs) from traffic performance management data (e.g., traffic performance monitoring (PM) counters), e.g., for a network node (305a), a standalone carrier (305b), and/or a neighboring carrier (305c).

In some embodiments, the interference-related KPIs include at least one or more of a PUSCH SINR having a value below 2 dB and a PUCCH SINR having a value below 0 dB (e.g., “low” SINRs).

In some embodiments, the traffic performance management data includes data related to at least one or more of (i) at least one UE included in the cell, (ii) at least one UE removed from the cell, (iii) radio resource control (RRC) connections for the cell, (iv) physical resource block (PRB) utilization for the cell, and (v) consumed energy for the cell.

Because for massive forecasting, it may be difficult to implement advanced methods for time-series analysis, in some embodiments, time-series prediction is reduced to supervised learning. Supervised learning can consider a temporal nature of the data, etc. In some embodiments, an extreme gradient boosting trees (XGBoost) process is used as to create a classification model(s). In some embodiments, other algorithms for classification models can be used.

Operations of the method of some embodiments will now be further discussed.

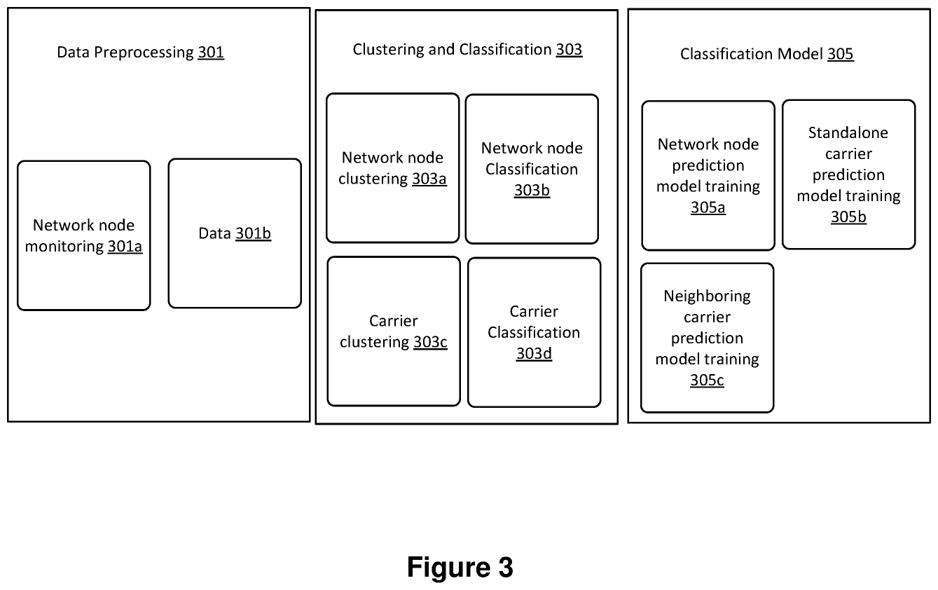

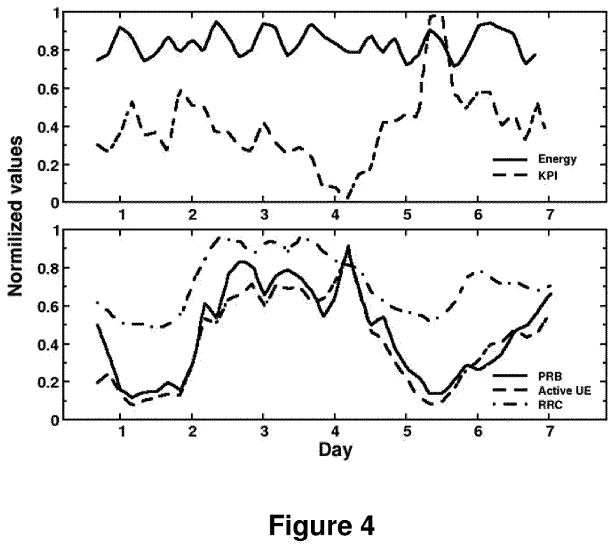

FIG. 4 is a plot illustrating an identified state of a network node having high interference and high consumed energy during day 5. FIG. 5 are plots illustrating an example embodiment of distribution of interference for a PUSCH SINR below a first defined threshold (e.g., below 2 dB), and a PUCCH SINR below a second defined threshold (e.g., 0 dB). Predicted interference KPIs for day 5 include a PUSCH SINR below 2 dB and/or a PUCCH SINR below 0 dB, as illustrated in FIG. 5. The predicted interference KPIS were predicted from traffic performance management data including PRB utilization for the cell, an active UE included in the cell, and RRC connections for the cell, as illustrated in FIG. 4. Day 5 of FIG. 4 illustrates that there is an increased power consumption peak that is caused by such interference.

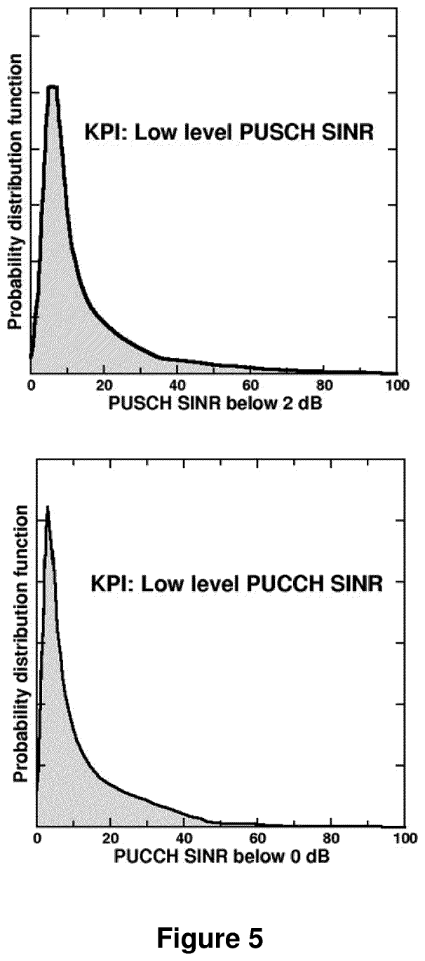

FIG. 6 is a flowchart illustrating operations in a network including the method in accordance with some embodiments of the present disclosure. In some embodiments, the method includes a hierarchical self-consistent carrier control process that can include three hierarchical levels: a site (network node) level 601, unit (carrier) level 603, and a carrier, local zone, and/or network level 605. Network node level 601 can include the network node identifying operation 201 of FIG. 2. Carrier level 603 can include a SINR-traffic model. Carrier, local zone, and/or network level 605 can include the selecting operation 203 of FIG. 2.

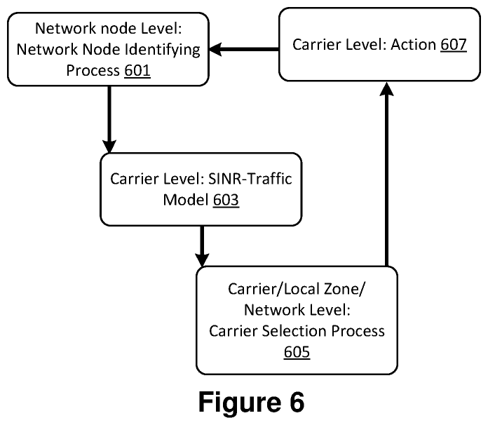

FIG. 7 is a flowchart illustrating further operations of a network node in accordance with some embodiments of the present disclosure. In some embodiments, the method further includes signalling (701) a request to lock the selected at least one carrier. Referring to FIG. 6, carrier level 607 can include an action(s) based on the request to lock the at least one carrier.

In some embodiments, the lock comprises a cell sleep mode or a cell turn off mode.

In some embodiments, the method further includes, when the selected at least one carrier can be locked, calculating (703) an energy efficient of the selected carrier, as discussed further herein.

Various operations from the flow chart of FIG. 7 may be optional with respect to some embodiments of network nodes and related method. For example, the operations of blocks 701 and 703 of FIG. 7 may be optional.

Carrier locking on a cell can lead to changes of traffic, interference conditions, and energy consumption for neighboring network nodes located in the local zone. A radius of a local zone for a network node can vary, as illustrated by FIG. 1A1. In some embodiments, a local zone radius is equal to a cell range. In other embodiments, azimuth or other data is added to define the local zone.

Referring again to FIG. 6, at the network node level 601, in some embodiments, the method includes the network node identifying operation 201 of FIG. 2. Network node identifying 201 can include identifying non-efficient network nodes having high interference. In some embodiments, network node identifying 201 can be implemented not only on carrier and radio levels but also on the whole network level (including, e.g., several radio units in different sectors).

In some embodiments, at carrier level 603, a SINR-traffic model is used to calculate an interference-energy-efficiency index for each carrier for the identified network node(s), as discussed further herein.

In some embodiments, at carrier/local zone/network level 605, a ML model selects a carrier(s) for the action (e.g., to lock the carrier(s) or to enter the carrier into a sleep mode). The carrier(s) can be chosen from a plurality of carriers.

In some embodiments, for the selected carrier(s), the action(s) can be implemented at cell level 607.

A loop of operations at levels 601-607 is referred to herein as a “self-consistent loop”. The self-consistent loop may allow the method of the present disclosure to reach a convergence that reduces interference, which may also improve energy-efficiency.

In some embodiments, the operations for carrier, local zone, and/or network levels can be distributed over multiple processors for the carrier, local zone, and/or network levels.

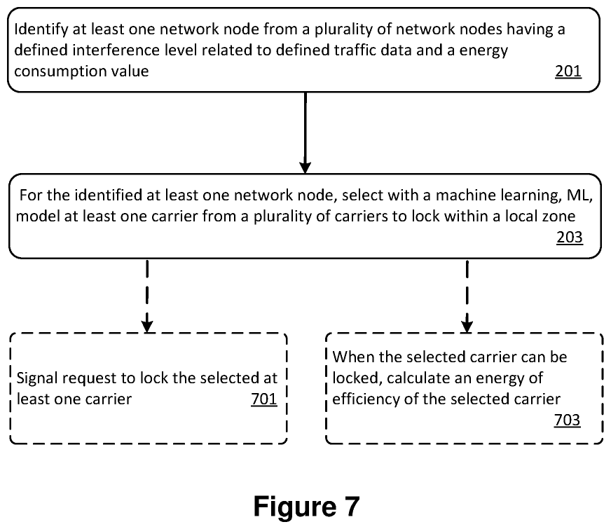

The identifying 201 of FIG. 2 at network node level 601 is now discussed further with respect to the flowchart of FIG. 8 in accordance with some embodiments.

In some embodiments, live data 801 and/or historical data 803 is used as inputs to calculate 805 an interference-energy-efficiency index. Live data 801 and/or historical data 803 can include PM counters and predicted KPIs. In some example embodiments, PM counters include example PMs identified with “pm” followed by a name/type of counter. The predicted KPIs can be calculated from the PM counters data. In some embodiments, the predicted KPIs and PM counters can include, without limitation:
PUSCH SINR below 2 dB (calculated from pmPuschSinr) (K_{low-PUSCH-SINR})
PUCCH SINR below 0 dB (calculated from pmPucchSinr) (K_{low-PUCCH-SINR})
pmConsumedEnergy (pmConsumedEnergy) (E_{consumed})
pmActiveUe (for uplink (UL)+pmActiveUe (for downlink DL) (N_{active-UE})
pmRrcConn (N_{RRC-estab})
pmPrbDL (PRB used for DL)+pmPrbUL (PRB used for UL) (N_{PRB})

As indicated, in some embodiments:
K_{low-PUSCH-SINR} is a PUSCH-SINR below 2 dB (calculated from pmPuschSinr)
K_{low-PUCCH-SINR} is a PUCCH SINR below 0 dB (calculated from pmPucchSinr)
E_{consumed} is the consumed energy (pmConsumedEnergy)
N_{active-UE} is an amount of active UEs (calculated as pmActiveUe (for UL)+pmActiveUe (for DL))
N_{RRC-estab} is an amount of established RRC connections (pmRrcConn)
N_{PRB} is an amount of used PRB (calculated as pmPrbDL+pmPrbUL)
An accumulated pmConsumedEnergy is used validation of pmConsumedEnergy

In some embodiments, data for every network node is aggregated and summed for a defined time period, e.g., per hour, per 15 minutes, etc. to calculate the interference-energy-efficiency index. In some embodiments, the calculation is as follows: ε_{active-UE} is the energy efficiency according to active users:

$${ε}_{active - UE} = \frac{{N}_{active - UE}}{{E}_{consumed}}$$

ε_{active-UE}^{min} and ε_{active-UE}^{max} are min and max of ε_{active-UE}:

$${θ}_{active - UE} = \frac{{ε}_{active - UE - {ε}_{active - UE}^{min}}}{{ε}_{active - UE}^{max} - {ε}_{active - UE}^{min}}$$

For a non-energy efficient node, θ_{active-UE}≤a defined energy efficiency (e.g., 0.5) Transmission of the same amount of payload consumes more energy:

$${ξ}_{{E}_{consumed}} = \frac{{E}_{consumed} - {E}_{consumed}^{min}}{{E}_{consumed}^{max} - {E}_{consumed}^{min}}$$

$${ξ}_{low - PUSCH - SINR} = \frac{{K}_{low - PUSCH - SINR} - {K}_{low - PUSCH - SINR}^{min}}{{K}_{low - PUSCH - SINR}^{max} - {K}_{low - PUSCH - SINR}^{min}}$$

States with high consumed energy caused by interference are defined from ξ_{consumed}≥a defined second threshold value (e.g., 0.4) and ξ_{low-PUSCH-SINR}≥a defined first threshold value (e.g., 0.6).
η_{iEE} is the interference-energy-efficiency (iEE) index, defined as:

$${η}_{e - i} = \frac{{ξ}_{active - UE} {ξ}_{used - PRB}}{{ξ}_{low - PUSCH - SINR} {ξ}_{{E}_{consumed}}}$$

In some embodiments, the identifying the at least one network node (operation 201 of FIG. 2) includes (i) calculating, on a per network node basis for the plurality of network nodes, an interference-energy-efficiency index corresponding to at least one of a carrier and a local zone of the at least network one node, and (ii) identifying the at least one network node based on the interference-energy-efficiency index.

In some embodiments, the interference-energy-efficiency index is based on at least one or more of (i) an energy efficiency based on a number of active UE, (ii) an energy efficiency of used PRBs, and (iii) an interference level based on a value of a SINR of at least one of a PUSCH and a PUCCH that is greater than or equal to a defined first threshold value, and (iv) a consumed energy value that is greater than or equal to a defined second threshold value.

In some embodiments, the interference-energy-efficiency index of the identified at least one network node includes at least one or more of an interference level based on a value of the SINR of at least one of the PUSCH and the PUCCH that is greater than or equal to the defined first threshold value, and a consumed energy value that is greater than or equal to the defined second threshold value.

In some embodiments, the value of the SINR is calculated from performance metric counter data, and the SINR has a distribution of SINR values for at least one of the PUSCH and the PUCCH.

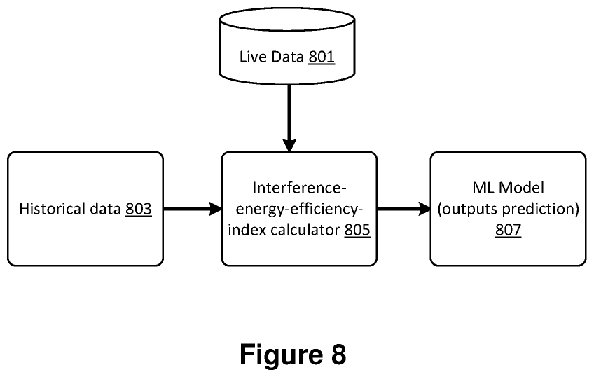

In some embodiments, carrier selection (operation 203 of FIG. 2) is performed by the network node using a carrier selection process illustrated in the flowchart of FIG. 9 that selects the at least one carrier for an action based on the interference-energy-efficiency index.

In operation 901, the network node initializes a set of carriers based on configuration data of neighboring cells (e.g., configurational capacity of neighboring cells). Reference signals of reference signal received power (RSRP) also can be added. In operation 903, the interference-energy-efficiency index is calculated for each initialized carrier. In some embodiments, the calculation is performed using a SINR-traffic model. In some embodiments, the SINR-traffic model is a classification model (e.g., a regression ML model) that predicts classes with low, medium, and high interference-related KPIs from performance management data (e.g., radio traffic counters which include and remove UEs, RRC connections, and PRB utilization for each carrier).

In step 905, the calculated interference-energy-efficiency index value for each carrier is ranked (e.g., in descending order or in ascending order). In some embodiments, in step 907, based on the ranking, the network node selects a carrier j based on the ranking (e.g., the carrier having the highest interference-energy-efficiency index value is selected). In step 909, a neighboring cell(s) to the cell for the selected carrier is evaluated for transferring a UE(s) using a minimum impact rate process.

In some embodiments, the minimum impact rate process allows the network node to evaluate the neighboring carrier(s) for transferring a UE(s) based on handover information.

In some embodiments, the evaluating is based on a minimum impact rate method that checks whether a UE can be transferred to a neighboring carrier from a plurality of neighboring carriers based on handover information.

In some embodiments, the ML model ranks the neighboring carriers based on a KPI that indicates a carrier capacity that meets requirements for an application of the UE that is available on a target carrier among the neighboring carriers. In some embodiments, the KPI includes, without limitation, low PRB utilization and related load; and the KPI level is acceptable for running or predicted application requirements of the UE (e.g., bandwidth and delay requirements).

In operation 911, the network node determines whether the selected carrier can be locked based on the outcome of operation 909.

In some embodiments, in operation 913 (also referred to in operation 703 of FIG. 7), the method further includes, when the selected carrier can be locked, calculating an energy efficiency of the selected carrier. In some embodiments, if the selected carrier cannot be locked, the operations of blocks 907-913 are repeated for additional carriers until a carrier is selected that can be locked.

In some embodiments, the selecting at least one carrier from the plurality of carriers of the identified at least one network node to lock (operation 203 of FIG. 2) includes (i) for the identified at least one network node, calculating an interference-energy efficiency index value per carrier, (ii) ranking the plurality of carriers according to the calculated interference-energy efficiency index values, (iii) choosing a carrier from the ranking to evaluate for locking, and (iv) evaluating the chosen carrier to determine whether the chosen carrier can be locked.

In some embodiments, the calculating the interference-energy efficiency index value per carrier is based on a SINR that the SINR-traffic model outputs as a predicted interference-related KPI.

In some embodiments, the carrier is chosen based on at least one of (i) a configuration capacity of a neighboring carrier indicating whether a UE can be transferred to the neighboring carrier, (ii) a reference signal received power, RSRP, and (iii) a reference signal received quality, RSRQ.

In another embodiment, selection of candidate carriers is based on cell relations. A carrier can have an associated Neighbor Relation Table (NRT) including cell relations (e.g., with a neighboring cell(s)) that the cell for the carrier typically handovers traffic to, either due to proximity and using over the air interfaces or due to fixed access via X2 links.

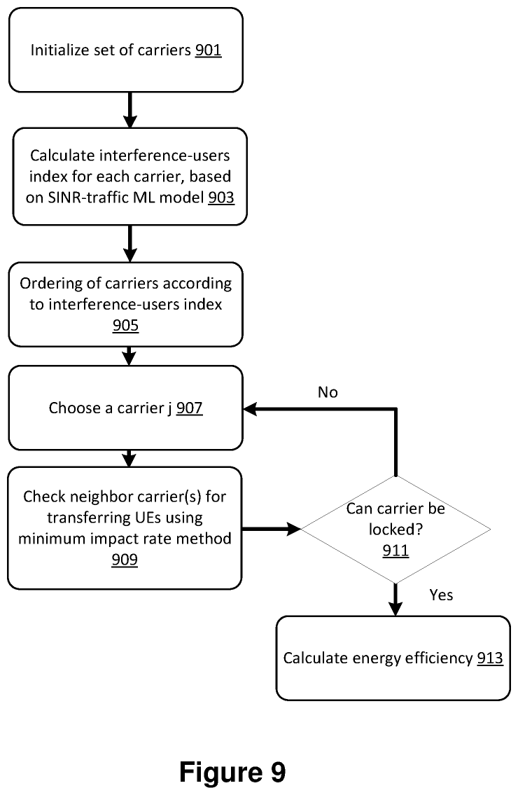

FIG. 10 is a schematic diagram illustrating an example visualization of such cells relations information. Cell 1 has two immediate neighbors, Cell 2 and Cell 3. As illustrated in FIG. 10, the cells relations information includes a number of handovers per neighbor from one cell to another cell in the direction of the indicated arrows, e.g., 30 handovers from Cell 1 to Cell 2 and 530 handovers from Cell 1 to Cell 3, accordingly. While this example is explained in the context of 30 handovers from Cell 1 to Cell 2 and 530 handovers from Cell 1 to Cell 3, the cells relations information is not so limited. Rather, the cells relation information may not be static and may vary over time, e.g., the number of handovers from one cell to another cell may vary over time. Using this information, the network node can decide to transfer traffic to the cell that has the most capacity (e.g., based on the lowest number of handovers), which in the case of Cell 1 in FIG. 10 is Cell 2. Additionally, the network node can treat this as a predictive problem, where the ML model is trained to predict the number of handovers per neighboring cells for next t timesteps. This can be implemented using different techniques such as auto regressive integrated moving average (ARIMA), long short-term memory (LSTM), and Temporal Graph Neural Networks.

While cell relations information of some embodiments is described with reference to a number of handovers per neighbor, cell relations information is not so limited. Instead, cell relations information may include any cell relations based information including, e.g., a number of active UEs, absolute capacity, etc. For example, considering that a UE may have a moving trajectory and may be expected to have an increasing distance to a selected candidate cell in relation to neighboring cell before handover, other factors can be added such as, e.g., a mobility prediction of the UE that predicts a next location of the UE.

In some embodiments, carrier selection (operation 203 of FIG. 2) can be performed using an algorithm to turn on a candidate cell using the following parameters:
Carrier: the carrier to be switched off
t: the current moment in time
candidateCell: the output of operations in this example embodiment, which pinpoints the neighboring cell(s) to handover traffic towards
minHandovers≤MAX_INTEGER
candidate_cell
   The algorithm using these parameters can be as follows:
for every neighboring_cell in cell.neighbors:
if neighbouring_cell.numHandovers[t+1]<minUtilization:
   where minUtilization is a complex formula of utilization per neighboring cell that combines handovers, energy consumption, RRC connections, interference, throughput, latency and/or other KPIs

This utilization per neighboring cell is collected and compared with neighboring cell(s), and the neighboring cell that has the lowest utilization is selected.

In a multi-vendor setup where utilization information is recorded centrally, this decision mechanism can be part of an Operations and Administration Management node. In other setups where utilization information is decentralized, an X2 interface between cells can be used to transfer such utilization information.

In another example embodiment, carrier selection (operation 203 of FIG. 2) can be performed using an algorithm to turn on a candidate cell using the following parameters:
Carrier: the carrier to be switched off
t: the current moment in time
candidateCell: the output of operations in this example embodiment, which pinpoints the neighboring cell(s) to handover traffic towards
minHandovers≤MAX_INTEGER
candidate_cell
   The algorithm using these parameters can be as follows:
for every neighboring_cell in cell.neighbors:
if neighbouring_cell.numHandovers[t+1]<minHandovers:
minHandovers=neighbouring_cell.numHandovers[t+1]
candidateCell=neighbourig_cell

Thus, instead of delivering a single candidate cell, multiple candidate cells can be produced. The produced candidate cells are sorted in ascending order (or descending order) based on the number of handovers. Algorithms such as Timsort (O(n log n)) can be set to produce such output.

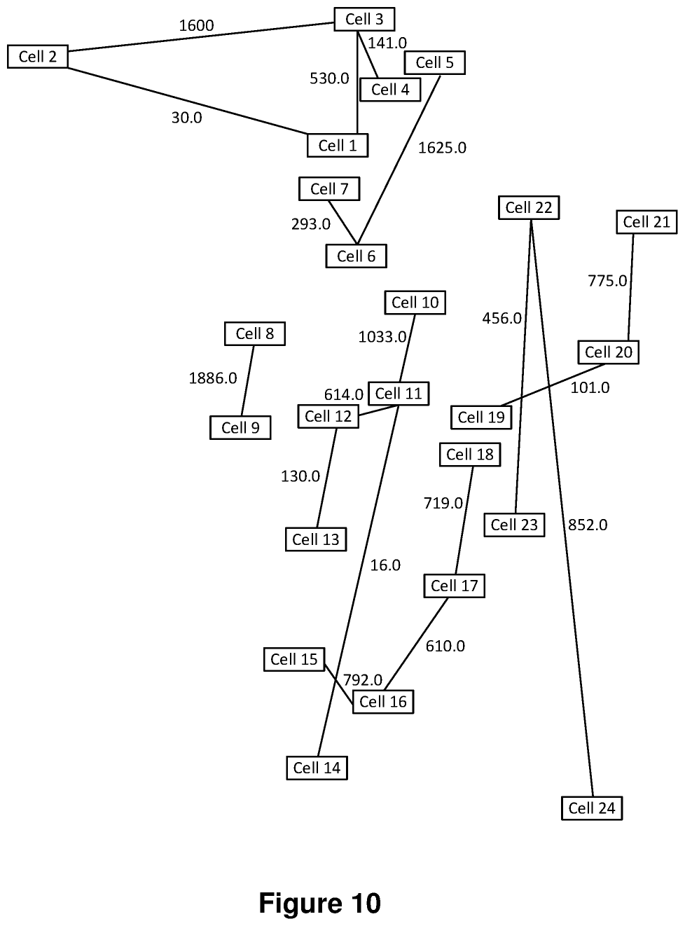

FIG. 11 is a block diagram illustrating connected operations of a network node in accordance with some embodiments of the present disclosure: self-consistent loop 601-607 of FIG. 6, ML model framework 1101, and an implementation framework 1103 for locking a carrier.

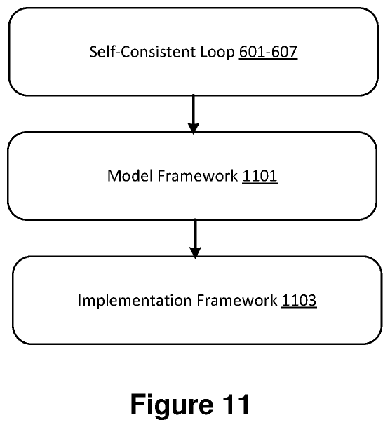

ML model framework 1101 is discussed with reference to FIG. 12. FIG. 12 is a flowchart illustrating operations of a network node implementing a ML model in accordance with some embodiments of the present disclosure. In some embodiments, configuration management (CM) and PM data from live monitoring 1201 may be used. In some embodiments, implementation can be performed on the edge or in the cloud.

Still referring to FIG. 12, in some embodiments, operations for edge implementation include observation 1203, detection 1205, selection 1207, validation 1209, recommendation 1211, and execution 1213. While FIG. 12 illustrates such operations in a certain order, the method of the present disclosure is not so limited. Instead, in some embodiments, the order of operations may be different and/or some operations may not be performed (e.g., depending on input features).

Observation 1203 of network nodes in a radio access network (RAN) can be performed by reading PM counters and related KPIs (discussed herein) and determining the network nodes that have available data.

In some embodiments, detection 1205 of a network node(s) is based on identification of a network node(s) having high interference and a related increased energy consumption.

In some embodiments, selection 1207 of a carrier from all the carriers for the identified network node is based on the carrier having high interference and less UE(s), and/or PRB utilization in comparison with other carriers.

In some embodiments, validation 1209 is performed on the chosen carrier(s) to check whether it is possible to transfer/offload UEs from the chosen carrier(s) to other carriers that have no/less interference. In some embodiments, multiple radio units with the same band or different bands are used in the network node(s) (e.g., illustrated in 1). Transferring active UEs to neighboring carriers is validated (also referred to herein as “checked”) based on the capacity of neighboring carriers.

In some embodiments, recommendation 1211 includes a recommendation of an action(s) and a time window for the action(s). In some embodiments, the recommendation is a soft lock of the selected carrier(s). In some embodiments, the recommendation is to turn off the selected carrier(s) or to place the selected carrier(s) in a sleep mode.

In some embodiments, additional data is added to the operations for recommendation 1211 for approving or canceling the recommended action(s). The additional data includes, without limitation RSRP, reference signal received quality (RSRQ) from a measurement report, quality of experience (QoE), and/or related UE throughput and latency metrics for approving/canceling a recommended action(s).

Execution 1213 of the recommended action(s) includes locking/turning off the selected carrier.

In some embodiments, live monitoring 1201 includes live monitoring of the operations of detection 1205 through recommendation 1211.

In some embodiments, control is dynamic and fast, e.g., 15 minute, 1 hour, etc. In some embodiments, training periodicity also is dynamic and fast, e.g., 1 week, 1 day, etc.; run periodicity is dynamic and fast, e.g., 1 day, 4-8 hours, etc.; and/or the prediction horizon is dynamic and fast, e.g., 1 day, 4-8 hours, etc.

Referring to cloud implementation, in some embodiments, cloud implementation includes the same operations as edge implementation (discussed herein). A main difference between the edge and cloud implementation is a type of ML model used, such as global (centralized) and isolated models.

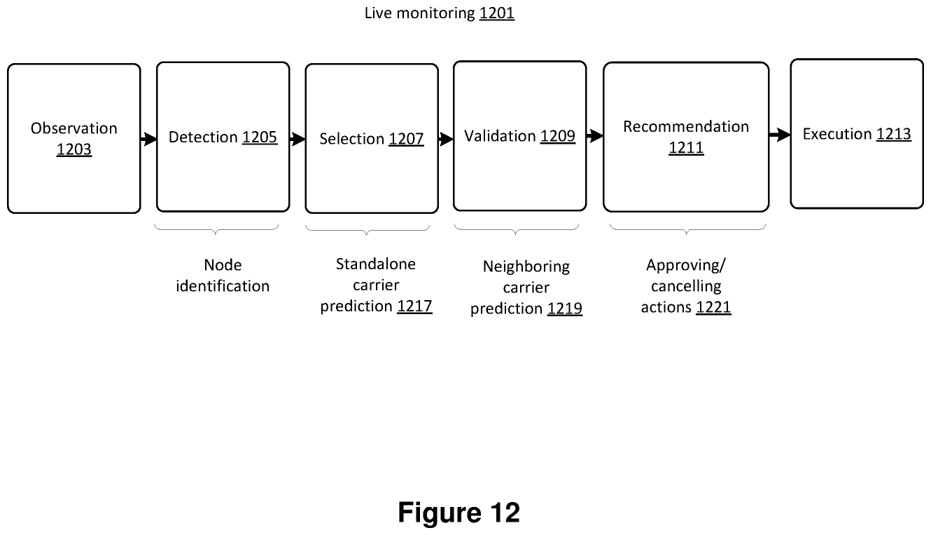

FIG. 13 is a block diagram illustrating implementation of isolated and centralized ML models of a network node in cloud layers in accordance with some embodiments of the present disclosure. Two cloud layers can be defined: a first cloud layer 1301 and a second cloud layer 1303. In the first cloud layer 1301, isolated and/or centralized models can be used; in the second cloud layer 1303, an isolated model(s) can be used. In some embodiments, two cloud layers are used because it may be difficult to forecast interference-related KPIs by using centralized models.

In some embodiments, a centralized model(s) is also used for classification in the identifying (operation 201 of FIG. 2).

In some embodiments, the method of the present disclosure may enable energy savings by detecting interference, recommending a time frame to make a soft lock (or other action) of a selected carrier(s), and validating the decision. As a consequence of the use of interference for making a locking decision, and validation of the decision, a transparent, and safe policy for locking/turning off cells may be provided.

As discussed herein, in some embodiments, the method is performed for a radio network. Network nodes affected by a lock/sleep/turn off mode on one of the network nodes are placed in a local zone of the network node performing the method of the present disclosure. In such embodiments, a local zone can be defined for each network node. Each local zone can be embedded in the radio network. A backward reply from the radio network to each network node is evaluated.

Optimization/improvement for each network node within the selected local zone can be performed by considering the backward reply from the radio network. These operations are repeated to receive convergence of optimized parameters to optimal/improved values for the radio network. After receiving the convergence of the optimized/improved parameters, other standard optimization techniques for configurational parameters can be applied.

Thus, carrier lock optimization/improvement based on interference KPIs can be done for the radio network. As a consequence, the method may help to effectively estimate the energy consumption of the radio network during the switching procedure and, therefore, optimize/improve the radio network's work to increase energy efficiency of the radio network while keeping its performance.

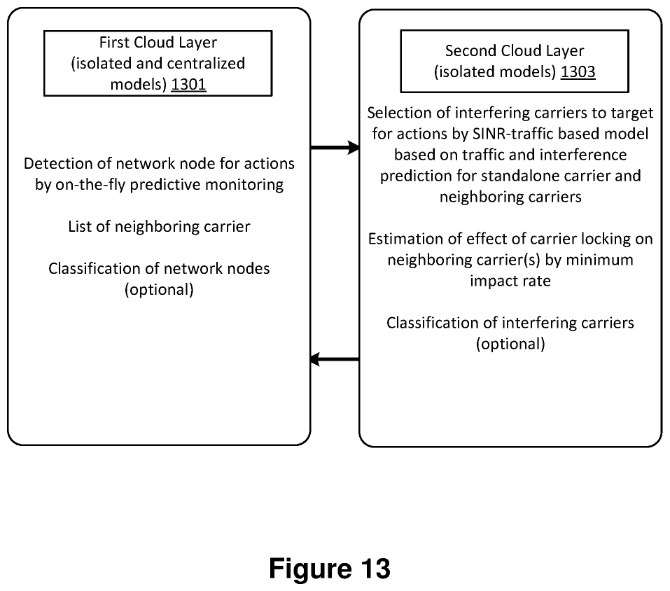

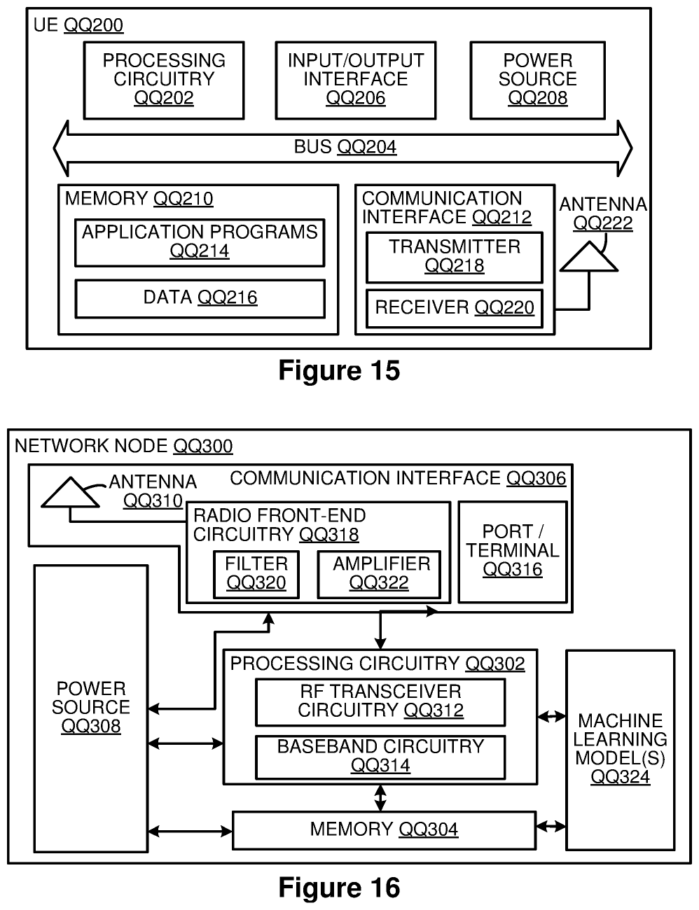

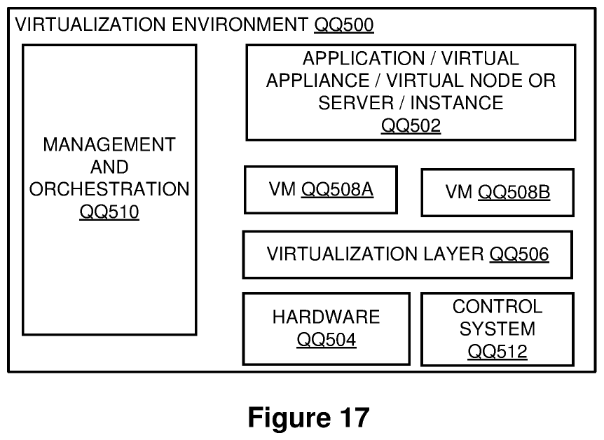

While embodiments discussed herein are explained in the non-limiting context of the network node implemented using the structure of network node QQ300 of FIG. 16, the invention is not so limited. A network node can be implemented using the structure of any of network node QQ110A/QQ110B of FIG. 14, QQ300 of FIG. 16, and/or hardware QQ504 or virtual machine QQ508A, QQ508B of FIG. 17, discussed further herein.

As discussed herein, operations of a network node may be performed by processing circuitry QQ302, ML model QQ324, and/or transceiver circuitry 601. For example, processing circuitry 603 may transceiver circuitry QQ312 to transmit communications through transceiver circuitry QQ312 over a radio interface to a radio access network node (also referred to as a base station) and/or to receive communications through transceiver circuitry QQ312 from a network node over a radio interface. The network node QQ300 may also include a machine learning (ML) model(s) QQ324 coupled to processor QQ302 and/or memory QQ304. In some embodiments, ML model(s) QQ324 can be connected to a wireless network and can transmit and receive information in accordance with some embodiments of the present disclosure. Moreover, modules may be stored in memory circuitry QQ304, and these modules may provide instructions so that when instructions of a module are executed by processing circuitry QQ302, processing circuitry QQ302 performs respective operations (e.g., operations discussed herein with respect to example embodiments relating to network nodes). According to some embodiments, a network node QQ300 and/or an element(s)/function(s) thereof may be embodied as a virtual node/nodes and/or a virtual machine/machines, as discussed further herein.

FIG. 14 shows an example of a communication system QQ100 in accordance with some embodiments.

In the example, the communication system QQ100 includes a telecommunication network QQ102 that includes an access network QQ104, such as a RAN, and a core network QQ106, which includes one or more core network nodes QQ108. The access network QQ104 includes one or more access nodes, such as network nodes QQ110a and QQ110b (one or more of which may be generally referred to as network nodes QQ110), or any other similar 3rd Generation Partnership Project (3GPP) access node or non-3GPP access point. The network nodes QQ110 facilitate direct or indirect connection of UE, such as by connecting UEs QQ112a, QQ112b, QQ112c, and QQ112d (one or more of which may be generally referred to as UEs QQ112) to the core network QQ106 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system QQ100 may include any number of wired or wireless networks, network nodes, UEs, and/or any other components or systems that may facilitate or participate in the communication of data and/or signals whether via wired or wireless connections. The communication system QQ100 may include and/or interface with any type of communication, telecommunication, data, cellular, radio network, and/or other similar type of system.

The UEs QQ112 may be any of a wide variety of communication devices, including wireless devices arranged, configured, and/or operable to communicate wirelessly with the network nodes QQ110 and other communication devices. Similarly, the nodes QQ110 are arranged, capable, configured, and/or operable to communicate directly or indirectly with the UEs QQ112 and/or with other nodes or equipment in the telecommunication network QQ102 to enable and/or provide network access, such as wireless network access, and/or to perform other functions, such as administration in the telecommunication network QQ102.

In the depicted example, the core network QQ106 connects the network nodes QQ110 to one or more hosts, such as host QQ116. These connections may be direct or indirect via one or more intermediary networks or devices. In other examples, nodes may be directly coupled to hosts. The core network QQ106 includes one more core network nodes (e.g., core network node QQ108) that are structured with hardware and software components. Features of these components may be substantially similar to those described with respect to the UEs, nodes, and/or hosts, such that the descriptions thereof are generally applicable to the corresponding components of the core network node QQ108. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host QQ116 may be under the ownership or control of a service provider other than an operator or provider of the access network QQ104 and/or the telecommunication network QQ102, and may be operated by the service provider or on behalf of the service provider. The host QQ116 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system QQ100 of FIG. 14 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network QQ102 is a cellular network that implements 3GPP standardized features. Accordingly, the telecommunications network QQ102 may support network slicing to provide different logical networks to different devices that are connected to the telecommunication network QQ102. For example, the telecommunications network QQ102 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs QQ112 are configured to transmit and/or receive information without direct human interaction. For instance, a UE may be designed to transmit information to the access network QQ104 on a predetermined schedule, when triggered by an internal or external event, or in response to requests from the access network QQ104. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub QQ114 communicates with the access network QQ104 to facilitate indirect communication between one or more UEs (e.g., UE QQ112c and/or QQ112d) and nodes (e.g., node QQ110b). In some examples, the hub QQ114 may be a controller, router, content source and analytics, or any of the other communication devices described herein regarding UEs. For example, the hub QQ114 may be a broadband router enabling access to the core network QQ106 for the UEs. As another example, the hub QQ114 may be a controller that sends commands or instructions to one or more actuators in the UEs. Commands or instructions may be received from the UEs, nodes QQ110, or by executable code, script, process, or other instructions in the hub QQ114. As another example, the hub QQ114 may be a data collector that acts as temporary storage for UE data and, in some embodiments, may perform analysis or other processing of the data. As another example, the hub QQ114 may be a content source. For example, for a UE that is a VR headset, display, loudspeaker or other media delivery device, the hub QQ114 may retrieve VR assets, video, audio, or other media or data related to sensory information via a network node, which the hub QQ114 then provides to the UE either directly, after performing local processing, and/or after adding additional local content. In still another example, the hub QQ114 acts as a proxy server or orchestrator for the UEs, in particular in if one or more of the UEs are low energy IoT devices.

The hub QQ114 may have a constant/persistent or intermittent connection to the node QQ110b. The hub QQ114 may also allow for a different communication scheme and/or schedule between the hub QQ114 and UEs (e.g., UE QQ112c and/or QQ112d), and between the hub QQ114 and the core network QQ106. In other examples, the hub QQ114 is connected to the core network QQ106 and/or one or more UEs via a wired connection. Moreover, the hub QQ114 may be configured to connect to an M2M service provider over the access network QQ104 and/or to another UE over a direct connection. In some scenarios, UEs may establish a wireless connection with the network nodes QQ110 while still connected via the hub QQ114 via a wired or wireless connection. In some embodiments, the hub QQ114 may be a dedicated hub—that is, a hub whose primary function is to route communications to/from the UEs from/to the node QQ110b. In other embodiments, the hub QQ114 may be a non-dedicated hub—that is, a device which is capable of operating to route communications between the UEs and node QQ110b, but which is additionally capable of operating as a communication start and/or end point for certain data channels.

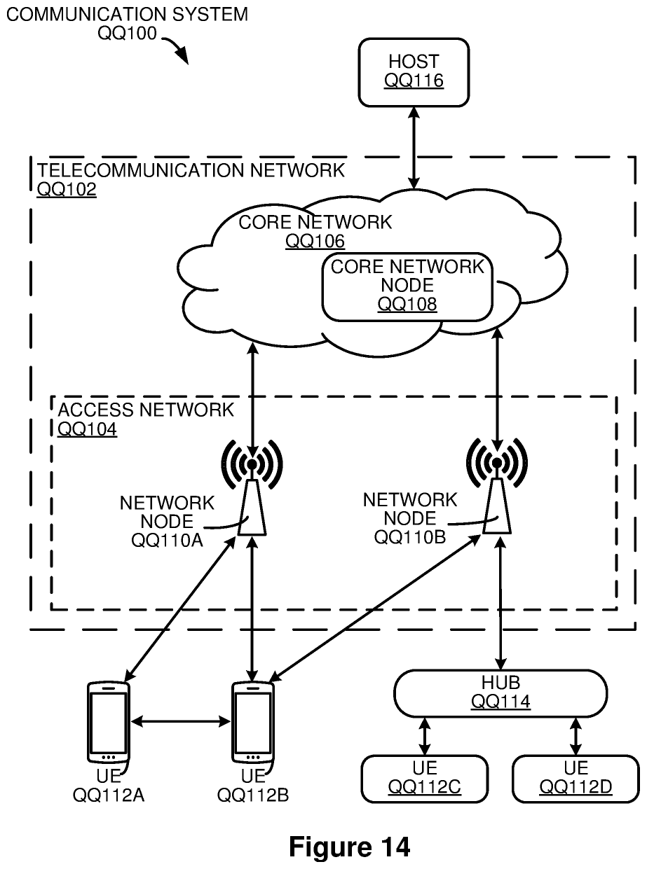

FIG. 15 shows a UE QQ200 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VOIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2 X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE QQ200 includes processing circuitry QQ202 that is operatively coupled via a bus QQ204 to an input/output interface QQ206, a power source QQ208, a memory QQ210, a communication interface QQ212, and/or any other component, or any combination thereof. Certain UEs may utilize all or a subset of the components shown in FIG. 14. The level of integration between the components may vary from one UE to another UE. Further, certain UEs may contain multiple instances of a component, such as multiple processors, memories, transceivers, transmitters, receivers, etc.

The processing circuitry QQ202 is configured to process instructions and data and may be configured to implement any sequential state machine operative to execute instructions stored as machine-readable computer programs in the memory QQ210. The processing circuitry QQ202 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry QQ202 may include multiple central processing units (CPUs).

In the example, the input/output interface QQ206 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE QQ200. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source QQ208 is structured as a battery or battery pack. Other types of power sources, such as an external power source (e.g., an electricity outlet), photovoltaic device, or power cell, may be used. The power source QQ208 may further include power circuitry for delivering power from the power source QQ208 itself, and/or an external power source, to the various parts of the UE QQ200 via input circuitry or an interface such as an electrical power cable. Delivering power may be, for example, for charging of the power source QQ208. Power circuitry may perform any formatting, converting, or other modification to the power from the power source QQ208 to make the power suitable for the respective components of the UE QQ200 to which power is supplied.

The memory QQ210 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory QQ210 includes one or more application programs QQ214, such as an operating system, web browser application, a widget, gadget engine, or other application, and corresponding data QQ216. The memory QQ210 may store, for use by the UE QQ200, any of a variety of various operating systems or combinations of operating systems.

The memory QQ210 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory QQ210 may allow the UE QQ200 to access instructions, application programs and the like, stored on transitory or non-transitory memory media, to off-load data, or to upload data. An article of manufacture, such as one utilizing a communication system may be tangibly embodied as or in the memory QQ210, which may be or comprise a device-readable storage medium.

The processing circuitry QQ202 may be configured to communicate with an access network or other network using the communication interface QQ212. The communication interface QQ212 may comprise one or more communication subsystems and may include or be communicatively coupled to an antenna QQ222. The communication interface QQ212 may include one or more transceivers used to communicate, such as by communicating with one or more remote transceivers of another device capable of wireless communication (e.g., another UE or a network node in an access network). Each transceiver may include a transmitter QQ218 and/or a receiver QQ220 appropriate to provide network communications (e.g., optical, electrical, frequency allocations, and so forth). Moreover, the transmitter QQ218 and receiver QQ220 may be coupled to one or more antennas (e.g., antenna QQ222) and may share circuit components, software or firmware, or alternatively be implemented separately.

In the illustrated embodiment, communication functions of the communication interface QQ212 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface QQ212, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected, an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE QQ200 shown in FIG. 14.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 16 shows a network node QQ300 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, base stations (BSs) (e.g., Node Bs, evolved Node Bs (eNBs) and NR NodeBs (gNBs)), and access points (APs) (e.g., radio access points).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A node may also include one or more (or all) parts of a distributed base station such as centralized digital units and/or remote radio units (RRUs), sometimes referred to as Remote Radio Heads (RRHs). Such remote radio units may or may not be integrated with an antenna as an antenna integrated radio. Parts of a distributed base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node QQ300 includes a processing circuitry QQ302, a memory QQ304, a communication interface QQ306, and a power source QQ308. The network node QQ300 may be composed of multiple physically separate components (e.g., a NodeB component and a RNC component, or a BTS component and a BSC component, etc.), which may each have their own respective components. In certain scenarios in which the network node QQ300 comprises multiple separate components (e.g., BTS and BSC components), one or more of the separate components may be shared among several nodes. For example, a single RNC may control multiple NodeBs. In such a scenario, each unique NodeB and RNC pair, may in some instances be considered a single separate node. In some embodiments, the network node QQ300 may be configured to support multiple radio access technologies (RATs). In such embodiments, some components may be duplicated (e.g., separate memory QQ304 for different RATs) and some components may be reused (e.g., a same antenna QQ310 may be shared by different RATs). The network node QQ300 may also include multiple sets of the various illustrated components for different wireless technologies integrated into network node QQ300, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node QQ300.

The processing circuitry QQ302 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node QQ300 components, such as the memory QQ304, to provide node QQ300 functionality.

In some embodiments, the processing circuitry QQ302 includes a system on a chip (SOC). In some embodiments, the processing circuitry QQ302 includes one or more of radio frequency (RF) transceiver circuitry QQ312 and baseband processing circuitry QQ314. In some embodiments, the radio frequency (RF) transceiver circuitry QQ312 and the baseband processing circuitry QQ314 may be on separate chips (or sets of chips), boards, or units, such as radio units and digital units. In alternative embodiments, part or all of RF transceiver circuitry QQ312 and baseband processing circuitry QQ314 may be on the same chip or set of chips, boards, or units.

The memory QQ304 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry QQ302. The memory QQ304 may store any suitable instructions, data, or information, including a computer program, software, an application including one or more of logic, rules, code, tables, and/or other instructions capable of being executed by the processing circuitry QQ302 and utilized by the node network QQ300. The memory QQ304 may be used to store any calculations made by the processing circuitry QQ302 and/or any data received via the communication interface QQ306. In some embodiments, the processing circuitry QQ302 and memory QQ304 is integrated.

The communication interface QQ306 is used in wired or wireless communication of signaling and/or data between a node, access network, and/or UE. As illustrated, the communication interface QQ306 comprises port(s)/terminal(s) QQ316 to send and receive data, for example to and from a network over a wired connection. The communication interface QQ306 also includes radio front-end circuitry QQ318 that may be coupled to, or in certain embodiments a part of, the antenna QQ310. Radio front-end circuitry QQ318 comprises filters QQ320 and amplifiers QQ322. The radio front-end circuitry QQ318 may be connected to an antenna QQ310 and processing circuitry QQ302. The radio front-end circuitry may be configured to condition signals communicated between antenna QQ310 and processing circuitry QQ302. The radio front-end circuitry QQ318 may receive digital data that is to be sent out to other network nodes or UEs via a wireless connection. The radio front-end circuitry QQ318 may convert the digital data into a radio signal having the appropriate channel and bandwidth parameters using a combination of filters QQ320 and/or amplifiers QQ322. The radio signal may then be transmitted via the antenna QQ310. Similarly, when receiving data, the antenna QQ310 may collect radio signals which are then converted into digital data by the radio front-end circuitry QQ318. The digital data may be passed to the processing circuitry QQ302. In other embodiments, the communication interface may comprise different components and/or different combinations of components.

In certain alternative embodiments, the network node QQ300 does not include separate radio front-end circuitry QQ318, instead, the processing circuitry QQ302 includes radio front-end circuitry and is connected to the antenna QQ310. Similarly, in some embodiments, all or some of the RF transceiver circuitry QQ312 is part of the communication interface QQ306. In still other embodiments, the communication interface QQ306 includes one or more ports or terminals QQ316, the radio front-end circuitry QQ318, and the RF transceiver circuitry QQ312, as part of a radio unit (not shown), and the communication interface QQ306 communicates with the baseband processing circuitry QQ314, which is part of a digital unit (not shown).

The antenna QQ310 may include one or more antennas, or antenna arrays, configured to send and/or receive wireless signals. The antenna QQ310 may be coupled to the radio front-end circuitry QQ318 and may be any type of antenna capable of transmitting and receiving data and/or signals wirelessly. In certain embodiments, the antenna QQ310 is separate from the network node QQ300 and connectable to the network node QQ300 through an interface or port.

The antenna QQ310, communication interface QQ306, and/or the processing circuitry QQ302 may be configured to perform any receiving operations and/or certain obtaining operations described herein as being performed by the node. Any information, data and/or signals may be received from a UE, another node and/or any other network equipment. Similarly, the antenna QQ310, the communication interface QQ306, and/or the processing circuitry QQ302 may be configured to perform any transmitting operations described herein as being performed by the node. Any information, data and/or signals may be transmitted to a UE, another node and/or any other network equipment.

The power source QQ308 provides power to the various components of network node QQ300 in a form suitable for the respective components (e.g., at a voltage and current level needed for each respective component). The power source QQ308 may further comprise, or be coupled to, power management circuitry to supply the components of the network node QQ300 with power for performing the functionality described herein. For example, the network node QQ300 may be connectable to an external power source (e.g., the power grid, an electricity outlet) via an input circuitry or interface such as an electrical cable, whereby the external power source supplies power to power circuitry of the power source QQ308. As a further example, the power source QQ308 may comprise a source of power in the form of a battery or battery pack which is connected to, or integrated in, power circuitry. The battery may provide backup power should the external power source fail.

Embodiments of the network node QQ300 may include additional components beyond those shown in FIG. 16 for providing certain aspects of the network node's functionality, including any of the functionality described herein and/or any functionality necessary to support the subject matter described herein. For example, the network node QQ300 may include user interface equipment to allow input of information into the network node QQ300 and to allow output of information from the network node QQ300. This may allow a user to perform diagnostic, maintenance, repair, and other administrative functions for the network node QQ300.

FIG. 17 is a block diagram illustrating a virtualization environment QQ500 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments QQ500 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications QQ502 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware QQ504 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers QQ506 (also referred to as hypervisors or virtual machine monitors (VMMs)), provide VMs QQ508a and QQ508b (one or more of which may be generally referred to as VMs QQ508), and/or perform any of the functions, features and/or benefits described in relation with some embodiments described herein. The virtualization layer QQ506 may present a virtual operating platform that appears like networking hardware to the VMs QQ508.

The VMs QQ508 comprise virtual processing, virtual memory, virtual networking or interface and virtual storage, and may be run by a corresponding virtualization layer QQ506. Different embodiments of the instance of a virtual appliance QQ502 may be implemented on one or more of VMs QQ508, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM QQ508 may be a software implementation of a physical machine that runs programs as if they were executing on a physical, non-virtualized machine. Each of the VMs QQ508, and that part of hardware QQ504 that executes that VM, be it hardware dedicated to that VM and/or hardware shared by that VM with others of the VMs, forms separate virtual network elements. Still in the context of NFV, a virtual network function is responsible for handling specific network functions that run in one or more VMs QQ508 on top of the hardware QQ504 and corresponds to the application QQ502.

Hardware QQ504 may be implemented in a standalone network node with generic or specific components. Hardware QQ504 may implement some functions via virtualization. Alternatively, hardware QQ504 may be part of a larger cluster of hardware (e.g. such as in a data center or CPE) where many hardware nodes work together and are managed via management and orchestration QQ510, which, among others, oversees lifecycle management of applications QQ502. In some embodiments, hardware QQ504 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system QQ512 which may alternatively be used for communication between hardware nodes and radio units.

In the above description of various embodiments of the present disclosure, it is to be understood that the terminology used herein is for the purpose of describing particular embodiments only and is not intended to be limiting of present inventive concepts. Unless otherwise defined, all terms (including technical and scientific terms) used herein have the same meaning as commonly understood by one of ordinary skill in the art to which present inventive concepts belong. It will be further understood that terms, such as those defined in commonly used dictionaries, should be interpreted as having a meaning that is consistent with their meaning in the context of this specification and the relevant art and will not be interpreted in an idealized or overly formal sense unless expressly so defined herein.

When an element is referred to as being “connected”, “coupled”, “responsive”, or variants thereof to another element, it can be directly connected, coupled, or responsive to the other element or intervening elements may be present. In contrast, when an element is referred to as being “directly connected”, “directly coupled”, “directly responsive”, or variants thereof to another element, there are no intervening elements present. Like numbers refer to like elements throughout. Furthermore, “coupled”, “connected”, “responsive”, or variants thereof as used herein may include wirelessly coupled, connected, or responsive. As used herein, the singular forms “a”, “an” and “the” are intended to include the plural forms as well, unless the context clearly indicates otherwise. Well-known functions or constructions may not be described in detail for brevity and/or clarity. The term “and/or” includes any and all combinations of one or more of the associated listed items.

It will be understood that although the terms first, second, third, etc. may be used herein to describe various elements/operations, these elements/operations should not be limited by these terms. These terms are only used to distinguish one element/operation from another element/operation. Thus, a first element/operation in some embodiments could be termed a second element/operation in other embodiments without departing from the teachings of present inventive concepts. The same reference numerals or the same reference designators denote the same or similar elements throughout the specification.

As used herein, the terms “comprise”, “comprising”, “comprises”, “include”, “including”, “includes”, “have”, “has”, “having”, or variants thereof are open-ended, and include one or more stated features, integers, elements, steps, components or functions but does not preclude the presence or addition of one or more other features, integers, elements, steps, components, functions or groups thereof. Furthermore, as used herein, the common abbreviation “e.g.”, which derives from the Latin phrase “exempli gratia,” may be used to introduce or specify a general example or examples of a previously mentioned item, and is not intended to be limiting of such item. The common abbreviation “i.e.”, which derives from the Latin phrase “id est,” may be used to specify a particular item from a more general recitation.

Example embodiments are described herein with reference to block diagrams and/or flowchart illustrations of computer-implemented methods, apparatus (systems and/or devices) and/or computer program products. It is understood that a block of the block diagrams and/or flowchart illustrations, and combinations of blocks in the block diagrams and/or flowchart illustrations, can be implemented by computer program instructions that are performed by one or more computer circuits. These computer program instructions may be provided to a processor circuit of a general purpose computer circuit, special purpose computer circuit, and/or other programmable data processing circuit to produce a machine, such that the instructions, which execute via the processor of the computer and/or other programmable data processing apparatus, transform and control transistors, values stored in memory locations, and other hardware components within such circuitry to implement the functions/acts specified in the block diagrams and/or flowchart block or blocks, and thereby create means (functionality) and/or structure for implementing the functions/acts specified in the block diagrams and/or flowchart block(s).

These computer program instructions may also be stored in a tangible computer-readable medium that can direct a computer or other programmable data processing apparatus to function in a particular manner, such that the instructions stored in the computer-readable medium produce an article of manufacture including instructions which implement the functions/acts specified in the block diagrams and/or flowchart block or blocks. Accordingly, embodiments of present inventive concepts may be embodied in hardware and/or in software (including firmware, resident software, micro-code, etc.) that runs on a processor such as a digital signal processor, which may collectively be referred to as “circuitry,” “a module” or variants thereof.

It should also be noted that in some alternate implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved. Moreover, the functionality of a given block of the flowcharts and/or block diagrams may be separated into multiple blocks and/or the functionality of two or more blocks of the flowcharts and/or block diagrams may be at least partially integrated. Finally, other blocks may be added/inserted between the blocks that are illustrated, and/or blocks/operations may be omitted without departing from the scope of inventive concepts. Moreover, although some of the diagrams include arrows on communication paths to show a primary direction of communication, it is to be understood that communication may occur in the opposite direction to the depicted arrows.

Many variations and modifications can be made to the embodiments without substantially departing from the principles of the present inventive concepts. All such variations and modifications are intended to be included herein within the scope of present inventive concepts. Accordingly, the above disclosed subject matter is to be considered illustrative, and not restrictive, and the examples of embodiments are intended to cover all such modifications, enhancements, and other embodiments, which fall within the spirit and scope of present inventive concepts. Thus, to the maximum extent allowed by law, the scope of present inventive concepts is to be determined by the broadest permissible interpretation of the present disclosure including the examples of embodiments and their equivalents, and shall not be restricted or limited by the foregoing detailed description.

1. A computer-implemented method performed by a network node to select at least one carrier to lock based on an interference level, the method comprising:
identifying at least one network node from a plurality of network nodes having a defined interference level related to defined traffic data and a energy consumption value; and
for the identified at least one network node, selecting with a machine learning, ML, model at least one carrier from a plurality of carriers to lock within a local zone.

2. The method of claim 1, further comprising:
signalling a request to lock the selected at least one carrier.

3. The method of claim 1, wherein the lock comprises a cell sleep mode or a cell turn off mode.

4. The method of claim 1, wherein the identifying is based on a clustering technique that clusters and classification of the plurality of network nodes.

5. The method of claim 4, wherein the plurality of network nodes are clustered and classified based on at least one or more of (i) network nodes that are energy efficient, (ii) network nodes that are non-energy efficient determined by a signal-to noise-interference-plus noise ratio, SINR, of at least one of a physical uplink shared channel, PUSCH, and a physical uplink control channel, PUCCH, that is greater than or equal to a defined first threshold value and determined into different local zones, (iii) network nodes that are not energy efficient nodes determined by a SINR of at least one of a PUSCH and a PUCCH that is less than the defined first threshold value, and (iv) a remainder of the plurality of network nodes.

6. The method of claim 1, wherein the identifying the at least one network node comprises (i) calculating, on a per network node basis for the plurality of network nodes, an interference-energy-efficiency index corresponding to at least one of a carrier and a local zone of the at least network one node, and (ii) identifying the at least one network node based on the interference-energy-efficiency index.

7. The method of claim 6, wherein the interference-energy-efficiency index is based on at least one or more of (i) an energy efficiency based on a number of active user equipment, (ii) an energy efficiency of used physical resource blocks, PRBs, and (iii) an interference level based on a value of a signal-to-interference-plus noise ratio, SINR, of at least one of a physical uplink shared channel, PUSCH, and a physical uplink control channel, PUCCH, that is greater than or equal to a defined first threshold value, and (iv) a consumed energy value that is greater than or equal to a defined second threshold value.

8. The method of claim 6, wherein the interference-energy-efficiency index of the identified at least one network node comprises at least one or more of an interference level based on a value of the SINR of at least one of the PUSCH and the PUCCH that is greater than or equal to the defined first threshold value, and a consumed energy value that is greater than or equal to the defined second threshold value.

9. The method of claim 5, wherein the value of the SINR is calculated from performance metric counter data, and wherein the SINR has a distribution of SINR values for at least one of the PUSCH and the PUCCH.

10. The method of claim 1, wherein the ML model is either a classification model or a regression model that predicts key performance indicators, KPIs, from traffic performance management data.

11. The method of claim 10, wherein the interference-related KPIs comprises at least one or more of a physical uplink shared channel, PUSCH, signal-to noise-interference-plus noise ratio, SINR, having a value below 2 dB and a physical uplink control channel, PUCCH, SINR having a value below 0 dB.

12. The method of claim 10, wherein the traffic performance management data comprises data related to at least one or more of (i) at least one user equipment included in a cell, (ii) at least one user equipment removed from the cell, (iii) radio resource control, RRC, connections for the cell, (iv) physical resource block, PRB, utilization for the cell, and (v) consumed energy for the cell.

13. The method of claim 1, wherein the selecting at least one carrier from the plurality of carriers of the identified at least one network node to lock comprises (i) for the identified at least one network node, calculating an interference-energy efficiency index value per carrier, (ii) ranking the plurality of carriers according to the calculated interference-energy efficiency index values, (iii) choosing a carrier from the ranking to evaluate for locking, and (iv) evaluating the chosen carrier to determine whether the chosen carrier can be locked.

14. The method of claim 13, wherein calculating the interference-energy efficiency index value per carrier is based on a signal-to-interference-plus noise ratio, SINR that the SINR-traffic model outputs as a predicted interference-related key performance indicators, KPI.

15. The method of claim 13, wherein the carrier is chosen based on at least one of (i) a configuration capacity of a neighboring carrier indicating whether a user equipment, UE, can be transferred to the neighboring carrier, (ii) a reference signal received power, RSRP, and (iii) a reference signal received quality, RSRQ.

16. The method of claim 13, wherein the evaluating is based on a minimum impact rate method that checks whether a user equipment, UE, can be transferred to a neighboring carrier from a plurality of neighboring carriers based on handover information.

17. The method of claim 16, wherein the ML model ranks the neighboring carriers based on a KPI that indicates a carrier capacity that meets a requirement for an application of the UE that is available on a target carrier among the neighboring carriers.

18. The method of claim 1, further comprising:
when the selected carrier can be locked, calculating an energy efficiency of the selected carrier.

19. The method of claim 1, wherein the network node comprises at least one of a base station, and edge node, and a cloud node.

20. A network node configured to select at least one carrier to lock based on an interference level, the network node comprising:
processing circuitry;
memory coupled with the processing circuitry, wherein the memory includes instructions that when executed by the processing circuitry causes the node to perform operations comprising:
identify at least one network node from a plurality of network nodes having a defined interference level related to defined traffic data and a energy consumption value; and
for the identified at least one network node, select with a machine learning, ML, model at least one carrier from a plurality of carriers to lock within a local zone.

21-25. (canceled)
